(19) United States
(12) Patent Application Publication
(10) Pub. No.: US 2026/0320505 A1
(43) Pub. Date: Oct. 15, 2026

(54) INFORMATION EXTRACTION SYSTEM USING ENSEMBLE MODEL AND VALIDATION METRIC FOR LARGE LANGUAGE MODELS

(71) Applicant: SAP SE, Walldorf (DE)

(72) Inventors: Yangyang Xiang, Singapore (SG); Ernest Hin Yui Liu, Singapore (SG); Hazel Chin, Singapore (SG); Mohamed Raizee Bin Mohamed Ibrahim, Singapore (SG); Hong Yong Wang, Singapore (SG); Jeremy Zhi Chen Yeo, Singapore (SG); Hanhui Wu, Singapore (SG); Quoc Hung Pham, Singapore (SG); Varun Tak, Singapore (SG)

(21) Appl. No.: 19/178,957

(22) Filed: Apr. 15, 2025

(51) Int. Cl. G06N 20/20; G06F 16/2455

(52) U.S. Cl. CPC G06N 20/20; G06F 16/2455

(57) ABSTRACT

Methods, systems, and computer-readable storage media for receiving a query document, processing the query document using an ensemble model to generate a results set responsive to the query document, the ensemble model comprising a pre-trained machine learning (ML) model that generates a first current result, a rule-based model that generates a second current result, and a large language model (LLM) that generates a third current result, determining, by a classifier, one of the first current result, the second current result, and the third current result to return as an extracted data result by arranging the first current result, the second current result, and the third current result into a feature vector processed by the classifier, updating a voting table to revise a number of votes for each of the pre-trained ML, the rule-based model, and the LLM, and returning the extracted data result.

### BACKGROUND

Enterprises continuously seek to improve and gain efficiencies in their operations. To this end, enterprises employ software systems to support execution of operations. Enterprises integrate systems in the domain of so-called intelligent enterprise, which can employ artificial intelligence (AI) that can include, for example, machine learning (ML) models. For example, AI can be used for data analytics and/or automating tasks in support of enterprise operations. In the field of AI, so-called generative AI (GAI) has recently seen an explosion in popularity. GAI can be described as including so-called foundation models that generate content based on training data. For example, foundation models can include large language models (LLMs), which are a form of GAI that can be used to generate text for a variety of use cases.

LLMs have demonstrated capabilities in various natural language processing (NLP) tasks, including information retrieval. As intelligent enterprise evolves, enterprises look to leverage the power of LLMs. This can include integrating LLMs to support functionality of services. However, integrating LLMs can present various technical challenges and can have disadvantages that have to be managed. For example, output generated by LLMs can be unreliable or hallucinated, making it crucial to validate the output before use in any downstream tasks.

### SUMMARY

Implementations of the present disclosure are directed to an information extraction system for extracting data from query documents. More particularly, implementations of the present disclosure are directed to an information extraction system that includes intelligent routing for selectively routing query documents to base models of a set of base models. In some implementations, for each query document, a base model is determined from the set of base models as being most accurate for the respective query document, and the base model is used to extract data from the query document.

In some implementations, actions include receiving a query document, processing the query document using an ensemble model to generate a results set responsive to the query document, the ensemble model comprising a pre-trained machine learning (ML) model that generates a first current result, a rule-based model that generates a second current result, and a large language model (LLM) that generates a third current result, determining, by a classifier, one of the first current result, the second current result, and the third current result to return as an extracted data result by arranging the first current result, the second current result, and the third current result into a feature vector processed by the classifier, updating a voting table to revise a number of votes for each of the pre-trained ML, the rule-based model, and the LLM, and returning the extracted data result. Other implementations of this aspect include corresponding systems, apparatus, and computer programs, configured to perform the actions of the methods, encoded on computer storage devices.

These and other implementations can each optionally include one or more of the following features: actions further include defining a set of sample documents based on similarity to the query document, wherein one or more sample documents in the set of sample documents is used to generate a few-shot prompt that is used to prompt the LLM to generate the third current result; actions further include generating a zero-shot prompt that is used to prompt the LLM to generate the third current result; the feature vector further includes a first historical result associated with the pre-trained ML, a second historical result associated with the rule-based model, and a third historical result associated with the LLM; actions further include executing a cross-validation based on the query document and one or more sample documents to provide a set of similarity scores, the set of similarity scores being used to update the voting table; the cross-validation includes comparing lines of the query document to lines of each of the one or more sample documents to determine similarity between field values; and each of the pre-trained ML model and the rule-based model is specific to one or more of a type of the query document and an enterprise that submitted the query document.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts a representation of an ensemble model in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to an information extraction system for extracting data from query documents. More particularly, implementations of the present disclosure are directed to an information extraction system that includes intelligent routing for selectively routing query documents to base models of a set of base models. In some implementations, for each query document, a base model is determined from the set of base models as being most accurate for the respective query document, and the base model is used to extract data from the query document.

Implementations can include actions of receiving a query document, processing the query document using an ensemble model to generate a results set responsive to the query document, the ensemble model comprising a pre-trained machine learning (ML) model that generates a first current result, a rule-based model that generates a second current result, and a large language model (LLM) that generates a third current result, determining, by a classifier, one of the first current result, the second current result, and the third current result to return as an extracted data result by arranging the first current result, the second current result, and the third current result into a feature vector processed by the classifier, updating a voting table to revise a number of votes for each of the pre-trained ML, the rule-based model, and the LLM, and returning the extracted data result.

To provide further context for implementations of the present disclosure, and as introduced above, enterprises continuously seek to improve and gain efficiencies in their operations and often employ software systems to support execution of operations. Example software systems can include information retrieval systems that can, for example, process documents to extract information recorded within the documents.

Traditional information retrieval systems, such as rule-based systems or systems using specialized machine learning (ML) models, often return validation metrics (e.g., confidence values, scores) that indicate the reliability of the extracted information. These validation metrics can be used to filter out low-confidence results or to prioritize high-confidence results for further processing. However, LLMs, which are trained on vast amounts of data across a spectrum of domains in a self-supervised manner, do not inherently provide such reliability metrics. This lack of direct validation metrics poses challenges in real-world use cases, where it is crucial to assess the trustworthiness of the extracted field values. The absence of direct validation metrics for LLM-based information retrieval can lead to difficulties in determining whether the extracted field values should be trusted or discarded.

To illustrate this, a non-limiting, example service can be considered, such as a document information extraction (DOX) service. In this example, a DOX service processes relatively large volumes of documents (e.g., documents of an enterprise) and extracts content (data) from headers, tables, and the like, represented in the documents. While DOX services have historically relied on rule-based and/or pre-trained ML models, enterprises seek to leverage the power of LLMs to enhance capabilities of DOX services. However, the absence of direct validation metrics for LLM-based information extraction presents a notable obstacle in integrating LLMs with DOX services.

Various methods have been investigated to validate information extractions performed by LLMs. A common approach involves using perplexity or log-likelihood as metrics to assess the trustworthiness of LLM-generated text. This approach is based on the principle that lower perplexity scores indicate superior ability of the LLM to predict subsequent words in a sequence, while higher scores suggest the LLM struggles with the generated content or lacks sufficient training on similar data. For open-weight LLMs, it is possible to calculate perplexity for each generated token, providing a granular view of the LLM's confidence. Popular closed-weight LLMs (e.g., Claude, Gemini, ChatGPT) offer log probabilities in their responses, which can be used to derive similar insights. However, this approach has limitations, particularly when dealing with multiple extraction fields. A single log probability for an entire response is insufficient to evaluate the confidence level for each individual field, presenting a challenge to assess the reliability of specific extracted information.

In view of the above context, implementations of the present disclosure provide an information extraction system that uses an ensemble approach in a cross-validation framework to combine the strengths of existing base services, such as DOX services, with advanced capabilities of LLMs. The cross-validation framework of the present disclosure provides a comprehensive, validation metric that represents the reliability of LLM-extracted field values. As described in further detail herein, implementations of the present disclosure integrate diverse base models and methodologies to establish a robust validation metric in, what is referred to herein as, an instant learning approach (InstantLearning) to enable informed decision-making and significantly enhance the trustworthiness of LLM-based information extraction in practical applications. As such, implementations of the present disclosure provide a significant step forward in bridging the gap between the capabilities of LLMs and the need for reliable, validated results in real-world document processing scenarios.

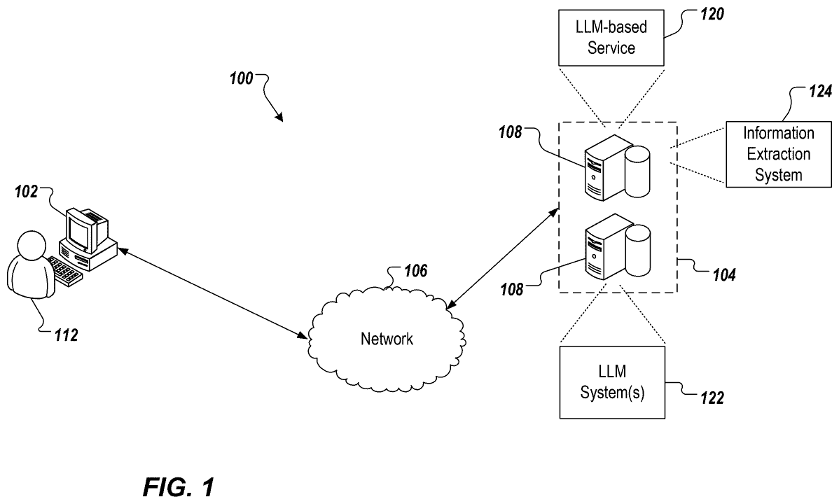

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In some implementations, the server system 104 can host a service 120 that execute functionality. In executing a function, the service 120 can leverage one or more LLMs provisioned within respective LLM systems 122 hosted within the server system 104. Example LLMs can include, but are not limited to, Gemini-1.0-pro, gemini-1.5-flash, gemini-1.5-pro, gpt-35-turbo, gpt-35-turbo-16 k, gpt-4, gpt-4-32 k, and gpt-40.

In accordance with implementations of the present disclosure, the server system 104 can host an information extraction system 124 that uses a set of base models, which includes a LLM of the one or more LLM systems 122, to extract data from query documents. In some examples, data that is extracted from a query document is processed by the service 120 for one or more downstream tasks. By way of non-limiting example, query documents can include invoices and bank statements that are processed by the information extraction system 124 to extract data, which data is processed by the service 120 to clear invoices in an automated invoice clearing process.

As described in further detail herein, implementations of the present disclosure provide an information extraction system (e.g., the information extraction system 124 of FIG. 1) that uses an ensemble approach with a cross-validation framework to leverage feedback and validate information extracted from documents using LLMs. In some examples, query documents (e.g., documents, from which information is to be extracted) are clustered based on layout using a continuous learning system. For documents without similar counterparts (e.g., documents that do not fit into a cluster), zero-shot prompting of a LLM can be executed and the results (e.g., information retrieved from the documents) are stored for future reference. In accordance with implementations of the present disclosure, users are able to rectify any inaccurate predictions. Here, user-corrected entries serve as examples for subsequent few-shot LLM queries.

In some implementations, query documents are routed to more straight-forward local models, such as a rule-based model or a pretrained ML model, for fields that were previously misidentified. In some examples, the local models are constructed using rules derived from the user-corrected document samples. To enhance accuracy, output of the LLM is validated by cross-referencing the results from the various models and comparing the results with historical predictions, utilizing information returned from sample documents. This multi-faceted approach ensures a robust and adaptive system that continually improves its performance based on user feedback and diverse modeling techniques.

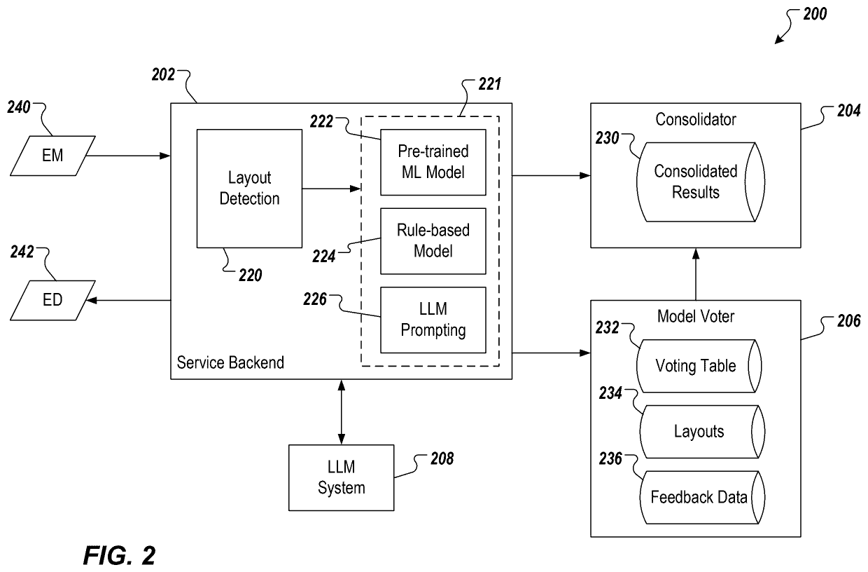

FIG. 2 depicts an example conceptual architecture 200 in accordance with implementations of the present disclosure. In the depicted example, the example conceptual architecture 200 includes a service backend 202 (e.g., the LLM-based service 120 of FIG. 1), a consolidator system 204 (e.g., part of the information extraction system 124 of FIG. 1), a model voter system 206 (e.g., part of the information extraction system 124 of FIG. 1), and one or more LLM systems 208 (e.g., the one or more LLM systems 122 of FIG. 1). In some examples, the service backend 202 includes a layout detection module 220 and an ensemble model 221 that includes a pre-trained model module 222, a rule-based model module 224, and a LLM prompting module 226. The consolidator system 204 includes a consolidated results store 230, and the model voter system 206 includes a voting table store 232, a layouts store 234, and a feedback data store 236.

In accordance with implementations of the present disclosure, and as described in further detail herein, the service backend 202 receives extractions messages, such as an extraction message 240, and returns extracted data, such as extracted data 242, that is responsive to the extraction message. For example, the extraction message 240 can include a query document, from which data is to be extracted and returned as the extracted data 242.

In further detail, the layout detection module 220 receives the query document of the extraction message 240 and processes the query document to define a set of sample documents. In some examples, the layout detection module 220 executes a similarity analysis to select a set of sample documents from a collection of sample documents. In some examples, the collection of sample documents is stored in the feedback data store 236. For example, a sample document can include a document that had been previously processed for automated document extraction that resulted in one or more inaccuracies. In response to the inaccuracies in the extracted data, user feedback is provided to correct the inaccuracies. As such, the document along with the corrected extracted data can be stored in the feedback data store 236 and can be selected as a sample document for subsequent automated document extraction (e.g., such as for the query document of the extraction message 240).

In some examples, sample documents in the collection of sample documents can each be associated with a particular enterprise in a set of enterprises. For example, multiple enterprises can use the information extraction system of the present disclosure to extract data from their respective documents. However, documents can differ between enterprises. Consequently, sample documents in the feedback data store 236 can be indexed to respective enterprises. For example, a first enterprise can interact with the information extraction system and provide feedback to multiple instances of data extraction, which results in sample documents of the first enterprise being stored in the feedback data store 236. As another example, a second enterprise has not yet interacted with the information extraction system and has not provided feedback to any instances of data extraction, which results in no sample documents for the second enterprise being stored in the feedback data store 236. Accordingly, in defining a set of sample documents for an extraction message received from a particular enterprise, a sub-collection of sample documents is determined, which includes only sample documents from the particular enterprise, and the similarity analysis is conducted for the sub-collection of sample documents.

In some implementations, sample documents added to the set of sample documents are considered to be sufficiently similar to the query document. This selection process considers aspects that can include document-level layout similarity, page-level information distribution similarity, and field-level schema similarity.

In some examples, document-level layout similarity is evaluated by comparing the overall structure and arrangement of elements between the query document and a sample document to provide a document-level layout similarity score. Accordingly, the document-level layout similarity ensures that sample documents that are selected closely match the format of the query document. Document-level similarity assesses the overlap of important corpus and their contextual positions within a document. The cumulative significance of these overlaps is used to determine the similarity between documents.

In some examples, page-level information distribution similarity is evaluated by comparing how information is spread across pages of the query document relative to a sample document to provide page-level information distribution similarity score. Page-level similarity considers the sequence of pages and the existence of recognized field values within pages. When employing LLMs for information extraction, corresponding pages from the sample document and query document are grouped to generate few-shot prompts. Pages lacking any ground truth fields are consequently omitted.

In some examples, field-level schema similarity is evaluated by comparing specific data fields and their relationships within the query document and a sample document, focusing on the semantic structure of the information. Field-level schema similarity is calculated based on the overlap of field names and field descriptions between schemas.

In accordance with implementations of the present disclosure, a set of sample documents is determined based on similarity. In some examples, one or more fields are identified for extraction within schemas, and the retrieval of sample documents for few-shot learning is conducted within the pre-defined schemas. For a given query document, a sample document cluster is chosen based on document-level similarity. If the similarity score falls below a pre-set threshold (e.g., 0.8), field-level schema similarity is used as a backup strategy. If a suitable sample document cannot be found, or if no sample document is linked to the given schema, schema similarity is used to avoid a zero-shot cold start, which can lead to performance degradation. Within the selected sample document cluster, page-level similarity is employed to select the most suitable sample document and to determine the configuration of few-shot prompting.

In accordance with implementations of the present disclosure, the ensemble model 221 is made up of a set of base models that include a pre-trained ML model that is executed by the pre-trained model module 222, a rule-based model that is executed by the rule-based model module 224, and a LLM of the LLM system 208 that is prompted by the LLM prompting module 226. In some examples, the pre-trained ML model is trained to extract data from query documents on training data that is representative of query documents of an enterprise. As such, the pre-trained ML model is specific to the enterprise that submits the extraction message 240. For example, the pre-trained model module 222 can access a set of pre-trained ML models, each specific to a respective enterprise, and can select the pre-trained ML model that is to be executed for the query document of the extraction message 240 based on the enterprise that submitted the extraction message 240. In some examples, the rule-based model is made of a set of rules that are used to locate data within query documents and extract data from query documents. As such, the rule-based model is specific to the enterprise that submits the extraction message 240. For example, the rule-based model module 224 can access a set of rule-based models, each specific to a respective enterprise, and can select the rule-based model that is to be executed for the query document of the extraction message 240 based on the enterprise that submitted the extraction message 240.

As described in further detail herein, the query document is processed through each of the base models of the ensemble model 221 to provide respective results, each result including data extracted from the query document. In some examples, the results are stored in the consolidated results store 230. In some implementations, a results set is processed through a classifier to determine which results to return in the extracted data 242. In some implementations, and as also described in further detail herein, cross-validation is performed to validate each of the results and update votes assigned to the respective base models within a voting table maintained in the voting table store 232.

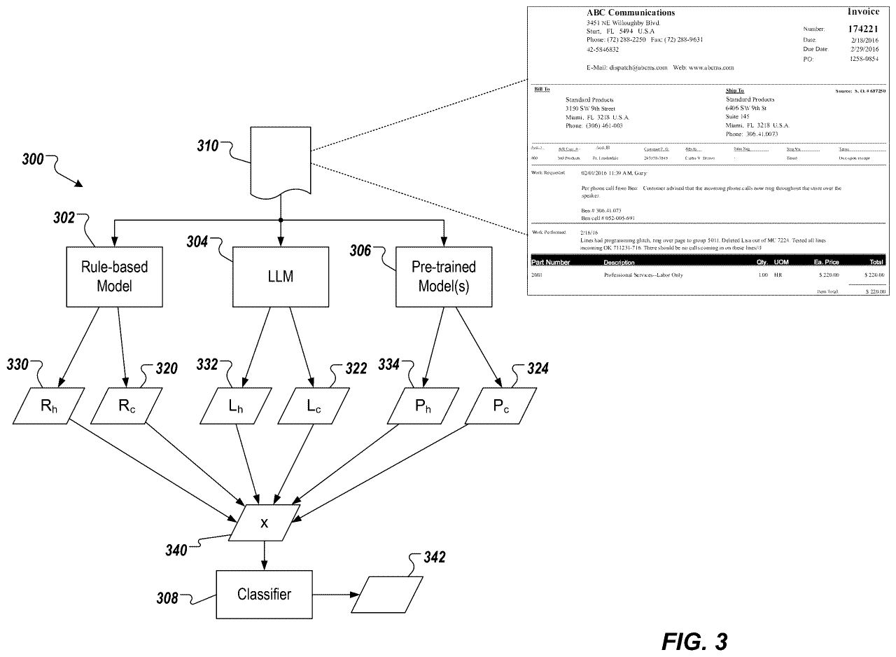

FIG. 3 depicts a representation of an ensemble model 300 in accordance with implementations of the present disclosure. In the example of FIG. 3, the ensemble model 300 includes a rule-based model 302, a LLM 304, a pre-trained model 306, and a classifier 308. In some examples, the rule-based model 302 processes documents by applying predefined patterns and heuristics represented in a set of rules to extract data. Rule-based models, such as the rule-based model 302, are particularly effective for structured data and/or with content including domain-specific terminology. In some examples, the pre-trained model 306 is one of a set of pre-trained models. In some examples, each pre-trained model can be described as a field-specific model that has been fine-tuned for a respective type of document (e.g., invoice, bank statement). In this manner, each pre-trained model 306 is specific to a respective type of document.

In some examples, a query document 310 is processed by each of the rule-based model 302, the LLM 304, and the pre-trained model 306 (selected based on a type of the query document 310) to provide a current result (R_{c}) 320, a current result (L_{c}) 322, and a current result (P_{c}) 324, respectively. More particularly, the query document 310 is input to each of the rule-based model 302 and the pre-trained model 306, which return the current result (R_{c}) 320 and the current result (P_{c}) 324, respectively.

However, in using the LLM 304 to provide the current result (L_{c}) 322, a prompt is generated (e.g., by the LL prompting module 226), which is used to prompt the LLM 304 (e.g., executed by the LLM system 208) to return the current result (L_{c}) 322. In some examples, the prompt is generated using a prompt template (e.g., stored in the layouts store 234 of FIG. 2). In some examples, the prompt template includes static content and placeholders, where static content includes content (e.g., text) that is the same for every prompt that is generated using the prompt template, and placeholders can be populated with content (e.g., text, file names, URLs) that is specific to a particular prompt. For example, one or more placeholders can be populated with a reference to the query document and/or content of the query document. In some examples, if few-shot prompting is to be used, the prompt template can be populated with reference to one or more sample documents and/or content of the one or more sample documents.

More particularly, and as described above with reference to FIG. 2, a set of sample documents is determined for the query document based on similarity to a collection (or sub-collection) of sample documents. In some examples, the set of documents can be an empty set. For example, it can be determined that there are no sample documents for the enterprise that sent the extraction message or that none of the sample documents of the enterprise that are stored in the feedback data store are deemed to be sufficiently similar to the query document. If the set of sample documents is empty, the LLM 304 is prompted using a zero-shot prompt. That is, no sample documents are provided with the prompt that the LLM 304 can use as context for processing the query document.

In some implementations, if the set of sample documents is non-empty, the prompt template is populated based on the sample documents in the set of sample documents. As described herein, the prompt template incorporates each sample document and corresponding ground truth data. More plainly stated, each sample document and respective ground truth data are used as few-shot examples for prompting of the LLM 304. In this manner, the LLM 304 is provided with concrete examples of the desired input-output relationship expected when processing the query document 310. This approach significantly enhances the ability of the LLM 304 to understand context of and accurately process the query document 310 to improve the performance of the LLM 304 in information extraction tasks. This is particularly the case when dealing with complex and/or domain-specific query documents that may require specialized knowledge or formatting considerations.

An example prompt can be provided as:
Task Instruction:
Extract information from document OCR results. The output should be formatted as a JSON instance that conforms to the JSON schema: {“properties”: {“documentdate”: {“title”: “documentdate”, “description”: “some description”, “type”: “array”, “items”: {“type”: “date”}}}, “required”: [“documentdate”]
Sample Document OCR
Here is an example document where the OCR string is provided: {ocr string}
Sample Output:
The desired output should look like this: {“documentdate”: “2016 Feb. 18}”
Query Extraction:
Extract the field values for the provided query document {ocr string}
   Here, “document OCR results” refers to content of the query document 310 that is provided using optical character recognition (OCR). For example, the query document 310 is received as a portable document format (.pdf) document that is processed using OCR.

In some implementations, a historical result (Rₕ) 330, a historical result (Lₕ) 332, and a historical result (Pₕ) 334 are provided for the rule-based model 302, the LLM 304, and the pre-trained model 306, respectively. In some examples, each of the historical result (Rₕ) 330, the historical result (Lₕ) 332, and the historical result (Pₕ) 334 represent past results generated by the respective models for the type of the query document 310.

In some examples, for the query document 310, a feature vector (x) 340 is provided as:

x=[Lₕ,L_{c},Rₕ,R_{c},Pₕ,P_{c}]

Accordingly, the feature vector (x) encapsulates both historical predictions and current predictions from the different models 302, 304, 306 included in the ensemble model 300. Here, multiple historical accuracies can be considered. For the pre-trained models, historical accuracy can be continuously monitored. However, for rule-based systems and LLMs, a sample document is required to initiate accuracy tracking. In a cold start system, the initial accuracy of few-shot learning could be set to zero following a zero-shot query. To further address this constraint, offline benchmarking results for different base models can be employed as a starting point. These benchmarking results can be used as a priority list to guide the model voting process and validate extraction outcomes.

In some implementations, to determine which results are to be returned for the query document 310, the feature vector 340 is processed through the classifier 308 to provide an output 342, the output 342 indicating which of the rule-based model 302, the LLM 304, and the pre-trained model 306 is best-performing, in terms of information extraction, for the query document 310. In some examples, the classifier 308 (e.g., a random forest model) is trained on a smaller, curated dataset to learn to map the feature vector 340 to an expected best-performing model. This approach provides for dynamic adaptation to different document types and extraction tasks, leveraging the strengths of each based model. By considering both historical performance and current predictions, the ensemble model 300 can make more informed decisions, leading to improved accuracy and consistency in information extraction across diverse document sets.

Implementations of the present disclosure further provide cross-validation that leverages page layout features to enhance the reliability and accuracy of results obtained from LLMs. In some implementations, during cross-validation, the results of the ensemble model are evaluated by comparing the query document to sample documents.

In further detail, Doc denotes the set of all lines in a document and line E Doc denotes an individual line containing a field value of interest. A similarity between two lines, a line from the query document (line_{q}) and a line from a sample document (lines) is determined using a probabilistic approach based on Bayes' theorem. In some examples, a similarity measure, also referred to herein as a similarity score, is formulated as:

$${s}_{sim} = P ( σ ( {line}_{q} , {line}_{s} ) \vert {fld}_{query}^{{line}_{q}} , {fld}_{sample}^{{line}_{s}} )$$

is the where σ(line_{q}, lineₛ) represents the similarity between the two lines,

$${fld}_{query}^{{line}_{q}}$$

is the field value extracted from the query document, and

$${fld}_{sample}^{{line}_{s}}$$

is the corresponding field value from the sample document. σ(line_{q}, lineₛ) is calculated based on string similarity and overlapping of OCR bounding boxes, and the value is normalized. In some examples, a Gaussian distribution for the similarity score, which enables natural variations in layout to be accounted for while still identifying significant discrepancies.

In some examples, and as described herein, the ensemble model considers historical accuracy as one of its features for predicting the best extraction from base models, integrating past performance with current query extraction. However, it is conceivable that none of the base models is considered sufficiently accurate. In such as case, it is necessary to further validate the outcomes of the ensemble model through cross-validation. This involves comparing contextual features between the query document and the sample document, where the contextual similarity is provided as sₛᵢₘ. During this cross-validation, historical accuracy does not provide significant insight because, regardless of its high value, there remains a chance that the current extraction could still be incorrect.

This cross-validation process of the present disclosure serves multiple purposes including consistency check, error detection, confidence scoring, adaptive learning, and multi-modal verification. With regard to consistency check, the extracted information is ensured to align with typical layout patterns observed in historical documents. With regard to error detection, by comparing with known correct samples, potential errors in the LLM extraction process can be identified. With regard to confidence scoring, the similarity score provides a quantitative assessment of the extraction confidence, which can be used for further decision-making or prioritization for human review. With regard to adaptive learning, the cross-validation can contribute to a feedback loop, enabling learning and adaptation to evolving document layouts and content patterns. With regard to multi-modal verification, by incorporating layout features, a spatial dimension is added to the text-based extraction, which creates a more robust and comprehensive validation mechanism.

In summary, the layout-based cross-validation of the present disclosure significantly enhances the overall reliability of the information extracted for query documents. Further, the layout-based cross-validation of the present disclosure acts as a safeguard against potential inconsistencies or errors introduced by the LLMs, ensuring that the final outputs are not only semantically accurate but also contextually and visually consistent with expected document structures. This is particularly valuable in domains where document layout carries significant meaning or where subtle spatial relationships between text elements can impact interpretation.

Referring again to FIG. 2, and as introduced above, votes assigned to the respective base models can be updated within the voting table maintained in the voting table store 232. In some examples, updating of the votes can be based on similarity measure (sₛᵢₘ) determined for the respective base models. For example, if the similarity measure (sₛᵢₘ) of a base model meets or exceeds a threshold similarity measure (sₛᵢₘₜₕᵣ), a vote count for the base model is incremented (up-vote) within the voting table. If the similarity measure (sₛᵢₘ) of a base model does not meet or exceed the threshold similarity measure (sₛᵢₘₜₕᵣ), the vote count for the base model is decremented (down-vote) within the voting table.

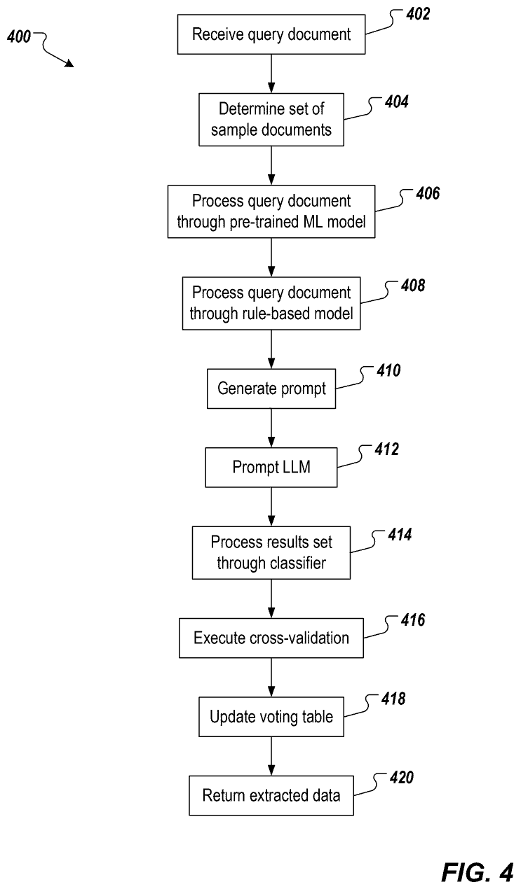

FIG. 4 depicts an example process 400 that can be executed in accordance with implementations of the present disclosure. In some examples, the example process 400 is provided using one or more computer-executable programs executed by one or more computing devices.

A query document is received (402) and a set of sample documents are determined (404). For example, and as described in detail herein with reference to FIG. 2, the service backend 202 receives the extraction message 240, which includes a query document, from which data is to be extracted. The layout detection module 220 receives the query document of the extraction message 240 and processes the query document to define a set of sample documents. In some examples, the layout detection module 220 executes a similarity analysis to select a set of sample documents from a collection of sample documents that is stored in the feedback data store 236.

The query document is processed through a pre-trained ML model (406) and through a rule-based model (408). For example, and as described in detail herein with reference to FIG. 3, the query document 310 is processed through the pre-trained model 306 and the rule-based model 302 to provide respective current results, namely, the current result (P_{c}) 324 and the current result (R_{c}) 320. A prompt is generated (410) and a LLM is prompted (412). For example, and as described in detail herein, a prompt is generated using a prompt template that is populated with a reference to and/or content of the query document. In some examples, the prompt template is selected from a set of prompt templates (e.g., stored within the layout store 234) and can be specific to the layout of the query document (e.g., invoice, bank statement) and/or the enterprise that submitted the extraction message. In response to the prompt, the LLM 304 returns the current result L_{c} 322.

A results set is processed though a classifier (414). For example, and as described in detail herein, a historical result (Rₕ) 330, a historical result (Lₕ) 332, and a historical result (Pₕ) 334 are provided for the rule-based model 302, the LLM 304, and the pre-trained model 306, respectively. In some examples, the results set, including the current results and the historical results, is used to populate a feature vector (x) 340 (e.g., x=[Lₕ, L_{c}, Rₕ, R_{c}, Pₕ, P_{c}]). The classifier 308 processes the feature vector (x) 340 to provide the output 342 indicating which of the rule-based model 302, the LLM 304, and the pre-trained model 306 is best-performing, in terms of information extraction, for the query document 310. Cross-validation is executed (416). For example, and as described in detail herein, a similarity score (sₛᵢₘ) is determined for each of the current results and indicates an accuracy of a respective results.

A voting table is updated (418). For example, and as described in detail herein, votes assigned to the respective base models can be updated within the voting table maintained in the voting table store 232. In some examples, updating of the votes can be based on similarity measure (sₛᵢₘ) determined for the respective base models. For example, if the similarity measure (sₛᵢₘ) of a base model meets or exceeds a threshold similarity measure (sₛᵢₘₜₕᵣ), a vote count for the base model is incremented (up-vote) within the voting table. If the similarity measure (sₛᵢₘ) of a base model does not meet or exceed the threshold similarity measure (sₛᵢₘₜₕᵣ), the vote count for the base model is decremented (down-vote) within the voting table. Extracted data is returned (420). For example, and as described in detail herein, results from one of the base models is returned as the extracted data 242.

As described in detail herein, implementations of the present disclosure provide multiple technical improvements and advantages over traditional approaches. More particularly, the information extraction system of the present disclosure has been shown to achieve significant improvements in accuracy when compared to traditional few-shot prediction methods.

Technical improvements and advantages are achieved through the intelligent routing described herein. More particularly, by analyzing the query documents that are provided as input for information extraction, the information extraction system of the present disclosure dynamically directs each query document to a base model that is determined to be most appropriate for the respective query document, resulting in substantially higher accuracy rates compared to conventional few-shot prediction approaches.

For example, the information extraction system of the present disclosure has been tested through multiple rounds of benchmarking, utilizing real-world datasets and employing GPT-4o, provided by OpenAI, as the foundational LLM. The comprehensive results of these tests are presented in Table 1:

TABLE 1
Example Benchmarking Results for Field Accuracies.

| Field | Zero-Shot | Few-Shot | InstantLearning |
|---|---|---|---|
| receiverAddress | 0.0199 | 0.4851 | 0.8530 |
| receiverName | 0.5778 | 0.7121 | 0.9521 |
| currencyCode | 0.8375 | 0.8994 | 0.9691 |
| deliveryDate | 0.7600 | 0.9200 | 0.9216 |
| discount | 0.9091 | 0.9091 | 0.8333 |
| dueDate | 0.6746 | 0.8214 | 0.9038 |
| receiverContact | 0.5652 | 0.7174 | 0.8626 |
| documentDate | 0.8265 | 0.8837 | 0.9400 |
| documentNumber | 0.6647 | 0.8647 | 0.9961 |
| paymentTerms | 0.6471 | 0.7618 | 0.8774 |
| purchaseOrderNumber | 0.7206 | 0.8162 | 0.9662 |
| netAmount | 0.8300 | 0.8703 | 0.9409 |
| tax1Amount | 0.5390 | 0.7872 | 0.9000 |
| tax1Name | 0.2043 | 0.6487 | 0.8716 |
| tax2Amount | 0.0000 | 0.6923 | 0.8696 |
| grossAmount | 0.8194 | 0.8835 | 0.9871 |
| senderAddress | 0.0237 | 0.5277 | 0.7298 |
| senderBankAccount | 0.1067 | 0.6402 | 0.9248 |
| senderName | 0.4907 | 0.7093 | 0.8516 |
| taxId | 0.0682 | 0.9072 | 0.9072 |

The example benchmarking results of Table 1 were determined using a dataset that contains 821 documents, grouped into 47 clusters based on layout similarity. Each cluster has a pre-selected sample document. Upon matching a query document to a cluster, few-shot learning is triggered, and accuracy monitoring begins for that cluster. Field accuracy (A_{fld}) is computed once all query documents have been processed based on the following relationship:

$${A}_{fld} = \frac{{t}_{p \_ gt}}{{f}_{n} + {f}_{p \_ gt} + {t}_{p \_ gt}}$$

where t_{p_gt} is true positive with ground truth present, fₙ is false negative, and f_{p_gt} is false positive with ground truth present. This approach accounts for the fact that not all documents contain every field, so extractions without corresponding ground truth data are disregarded.

Furthermore, an in-depth analysis of precision and recall rates across various confidence thresholds reveals that the confidence values of the present disclosure are statistically meaningful and highly correlated with prediction accuracy. In practical terms, this means that predictions associated with higher confidence values are significantly more likely to be correct. By adjusting the confidence threshold, users can effectively balance between precision and recall, tailoring behavior of the information extraction system to particular use cases. Moreover, implementations of the present disclosure solution offer enhanced interpretability and control over the prediction process. Users can gain insights into the decision-making process by examining the confidence values, allowing for better understanding and trust in the data extracted from the query documents. Accordingly, the information extraction system of the present disclosure not only improves overall prediction accuracy over traditional approaches, but also provides users with flexible, interpretable, and customizable AI-driven decision-making capabilities, representing a significant advancement in the field of few-shot learning and applications of LLMs.

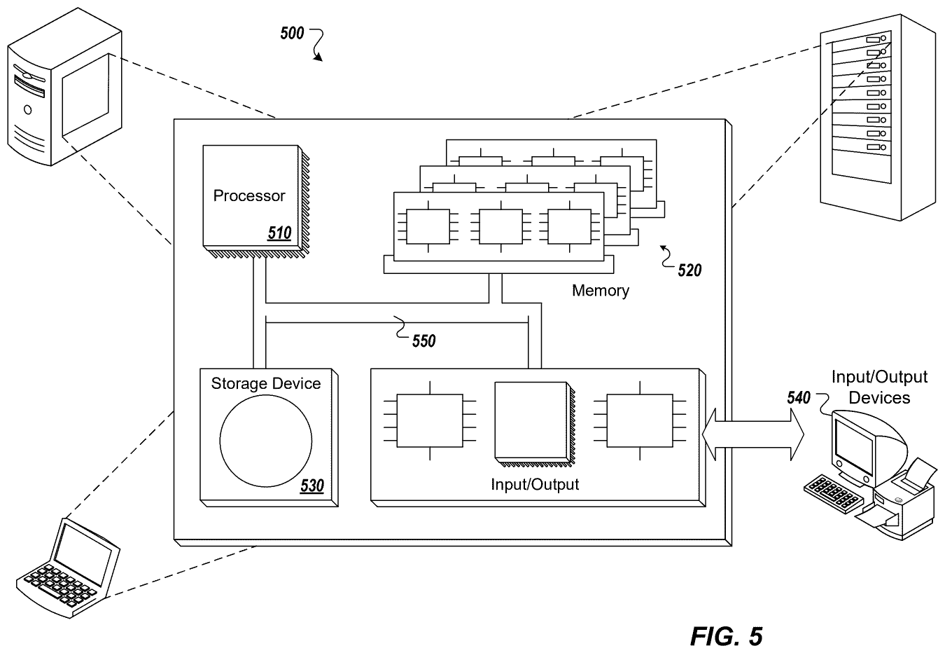

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for extracting data from computer-readable documents using a set of base models, the method being executed by one or more processors and comprising:
receiving a query document;
processing the query document using an ensemble model to generate a results set responsive to the query document, the ensemble model comprising a pre-trained machine learning (ML) model that generates a first current result, a rule-based model that generates a second current result, and a large language model (LLM) that generates a third current result;
determining, by a classifier, one of the first current result, the second current result, and the third current result to return as an extracted data result by arranging the first current result, the second current result, and the third current result into a feature vector processed by the classifier;
updating a voting table to revise a number of votes for each of the pre-trained ML, the rule-based model, and the LLM; and
returning the extracted data result.

2. The method of claim 1, further comprising defining a set of sample documents based on similarity to the query document, wherein one or more sample documents in the set of sample documents is used to generate a few-shot prompt that is used to prompt the LLM to generate the third current result.

3. The method of claim 1, further comprising generating a zero-shot prompt that is used to prompt the LLM to generate the third current result.

4. The method of claim 1, wherein the feature vector further comprises a first historical result associated with the pre-trained ML, a second historical result associated with the rule-based model, and a third historical result associated with the LLM.

5. The method of claim 1, further comprising executing a cross-validation based on the query document and one or more sample documents to provide a set of similarity scores, the set of similarity scores being used to update the voting table.

6. The method of claim 5, wherein the cross-validation comprises comparing lines of the query document to lines of each of the one or more sample documents to determine similarity between field values.

7. The method of claim 1, wherein each of the pre-trained ML model and the rule-based model is specific to one or more of a type of the query document and an enterprise that submitted the query document.

8. A non-transitory computer-readable storage medium coupled to one or more processors and having instructions stored thereon which, when executed by the one or more processors, cause the one or more processors to perform operations for extracting data from computer-readable documents using a set of base models, the operations comprising:
receiving a query document;
processing the query document using an ensemble model to generate a results set responsive to the query document, the ensemble model comprising a pre-trained machine learning (ML) model that generates a first current result, a rule-based model that generates a second current result, and a large language model (LLM) that generates a third current result;
determining, by a classifier, one of the first current result, the second current result, and the third current result to return as an extracted data result by arranging the first current result, the second current result, and the third current result into a feature vector processed by the classifier;
updating a voting table to revise a number of votes for each of the pre-trained ML, the rule-based model, and the LLM; and
returning the extracted data result.

9. The non-transitory computer-readable storage medium of claim 8, wherein operations further comprise defining a set of sample documents based on similarity to the query document, wherein one or more sample documents in the set of sample documents is used to generate a few-shot prompt that is used to prompt the LLM to generate the third current result.

10. The non-transitory computer-readable storage medium of claim 8, wherein operations further comprise generating a zero-shot prompt that is used to prompt the LLM to generate the third current result.

11. The non-transitory computer-readable storage medium of claim 8, wherein the feature vector further comprises a first historical result associated with the pre-trained ML, a second historical result associated with the rule-based model, and a third historical result associated with the LLM.

12. The non-transitory computer-readable storage medium of claim 8, wherein operations further comprise executing a cross-validation based on the query document and one or more sample documents to provide a set of similarity scores, the set of similarity scores being used to update the voting table.

13. The non-transitory computer-readable storage medium of claim 12, wherein the cross-validation comprises comparing lines of the query document to lines of each of the one or more sample documents to determine similarity between field values.

14. The non-transitory computer-readable storage medium of claim 8, wherein each of the pre-trained ML model and the rule-based model is specific to one or more of a type of the query document and an enterprise that submitted the query document.

15. A system, comprising:
a computing device; and
a computer-readable storage device coupled to the computing device and having instructions stored thereon which, when executed by the computing device, cause the computing device to perform operations for extracting data from computer-readable documents using a set of base models, the operations comprising:
receiving a query document;
processing the query document using an ensemble model to generate a results set responsive to the query document, the ensemble model comprising a pre-trained machine learning (ML) model that generates a first current result, a rule-based model that generates a second current result, and a large language model (LLM) that generates a third current result;
determining, by a classifier, one of the first current result, the second current result, and the third current result to return as an extracted data result by arranging the first current result, the second current result, and the third current result into a feature vector processed by the classifier;
updating a voting table to revise a number of votes for each of the pre-trained ML, the rule-based model, and the LLM; and
returning the extracted data result.

16. The system of claim 15, wherein operations further comprise defining a set of sample documents based on similarity to the query document, wherein one or more sample documents in the set of sample documents is used to generate a few-shot prompt that is used to prompt the LLM to generate the third current result.

17. The system of claim 15, wherein operations further comprise generating a zero-shot prompt that is used to prompt the LLM to generate the third current result.

18. The system of claim 15, wherein the feature vector further comprises a first historical result associated with the pre-trained ML, a second historical result associated with the rule-based model, and a third historical result associated with the LLM.

19. The system of claim 15, wherein operations further comprise executing a cross-validation based on the query document and one or more sample documents to provide a set of similarity scores, the set of similarity scores being used to update the voting table.

20. The system of claim 19, wherein the cross-validation comprises comparing lines of the query document to lines of each of the one or more sample documents to determine similarity between field values.
